(19) United States
(12) Patent Application Publication
(10) Pub. No.: US 2013/0098561 A1
(43) Pub. Date: Apr. 25, 2013

(54) Pivoting Valance System for Shades or Blinds and a Method for Pivoting a Valance

(71) Applicants: Willis Jay Mullet, Gulf Breeze, FL (US); Christopher Lee Wysoczynski, Gulf Breeze, FL (US)

(72) Inventors: Willis Jay Mullet, Gulf Breeze, FL (US); Christopher Lee Wysoczynski, Gulf Breeze, FL (US)

(73) Assignee: HOMERUN HOLDINGS CORPORATION, Pensacola, FL (US)

(21) Appl. No.: 13/276,928

(22) Filed: Oct. 19, 2011

(51) Int. Cl. E06B 9/50; E06B 9/00

(52) U.S. Cl. 160/29; 160/39; 160/405

(57) ABSTRACT

A system for supporting a window covering is provided. The system includes: a bracket assembly having a stationary portion and a pivoting portion; a valance pivotally connected to the bracket assembly; a first lock configured to lock the valance to the pivoting portion of the bracket assembly; and a second lock that, when engaged, locks the valance to the stationary portion of the bracket assembly. A method of concealing a window covering may also be provided. The method may include: providing a bracket assembly configured to support the window covering; providing a valence attached to the bracket assembly; pivoting the valance on the bracket assembly to selectively expose and conceal the window covering; locking the valance to a pivoting portion of the bracket assembly; and locking the valence to a stationary portion of the bracket assembly.

### FIELD OF THE INVENTION

The present invention relates generally to a system and apparatus for covering a window. More particularly, the present invention relates to a system and apparatus for providing a valance that can pivot to selectively provide access to the bracket assembly supporting the window cover and hide the bracket assembly supporting the window cover.

### BACKGROUND OF THE INVENTION

Window coverings serve multiple functions. For example coverings are used to limit light from coming in through the window. The window coverings are also used to provide privacy. In addition to these functions, window coverings also provide a decorative touch to a room.

Common window coverings include blinds and roller shades. Both blinds and roller shades use a bracket assembly located at the top or above the window to support the blinds or roller shade. The bracket assembly is usually roughly finished and unsightly. In order to cover the bracket assembly and the retracted blinds or roller shade a valance is often used. The valance provides an aesthetic feature to cover the utilitarian features of the window covering.

One problem that may be associated with some types of valances is that they may hinder access to the bracket assembly and or window covering. From time to time it may be desirable to be able to easily access the support brackets and/or the window covering. For example, during installation, removal and/or to maintain or adjust these features.

Accordingly, it is desirable to provide a method and apparatus that allows the use of a valance to cover the more unsightly portions of a window covering system yet provides relatively easy access to portions of the window system that is covered by the valance.

Further, in the case of roller shades, springs are often employed to assist in rotating the roller shades. As such, sometimes the roller shades may over rotate and spin when the roller shade is already fully retracted. This can cause excessive wear and/or potentially damage the window covering system.

Accordingly it may be desirable to provide a mechanism to prevent the roller shade from spinning when it is in a fully refracted position, but allow the roller shade to rotate when it is not in a fully retracted position.

### SUMMARY OF THE INVENTION

The foregoing needs are met, to a great extent, by the present invention, wherein in one aspect a method and apparatus is provided that allows the use of a valance to cover some of the unsightly portions of a window covering system yet provides relatively easy access to portions of the window system that is covered by the valance.

The foregoing needs are met, to a great extent, by the present invention, wherein in one aspect a method and apparatus is provided that prevents a roller shade from spinning when it is in a fully retracted position, but allows the roller shade to rotate when it is not in a fully retracted position.

In accordance with one embodiment of the present invention, a system for supporting a window covering is provided. The system includes: a bracket assembly having a stationary portion and a pivoting portion; a valance pivotally connected to the bracket assembly; a first lock configured to lock the valance to the pivoting portion of the bracket assembly; and a second lock that, when engaged, locks the valance to the stationary portion of the bracket assembly.

In accordance with another embodiment of the present invention, a method of concealing a window covering may also be provided. The method may include: providing a bracket assembly configured to support the window covering; providing a valance attached to the bracket assembly; pivoting the valance on the bracket assembly to selectively expose and conceal the window covering; locking the valance to a pivoting portion of the bracket assembly; and locking the valance to a stationary portion of the bracket assembly.

In accordance with yet another embodiment of the present invention, a system for supporting a window covering may be provided. The system may include a means for supporting the window covering having a stationary portion and a pivoting portion; a concealing means pivotally connected to the means for supporting the window covering; a first means for locking configured to lock the concealing means to the pivoting portion of the means for supporting the window covering; and a second locking means that, when engaged, locks the concealing means to the stationary portion of the means for supporting the window covering.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a roller shade or blind in accordance with an embodiment of the invention.

FIG. 2 is a perspective view of the roller shade or blind of FIG. 1 with the valance pivoted upward to allow servicing of the roller shade or blind.

FIG. 3 is a reverse exploded perspective view showing the components of the left bracket assembly and part of the valance of FIG. 1.

FIG. 4 is a reverse perspective view of the left side of the assembly with both the first snapping slide lock and the second slide lock in the unlocked position and the roller shade or blind removed.

FIG. 5 is a reverse perspective view of the left side of the assembly with both the first snapping slide lock and the second slide lock in the unlocked position, the valance rotated and the roll shade or blind removed.

FIG. 6 is a reverse perspective view of the left side of the assembly with both the first snapping slide lock and the second slide lock in the locked position and the roll shade or blind removed.

FIG. 7 is a reverse perspective view of the left side of the assembly with both the first slide lock and the second slide lock in the unlocked position, the valance being installed, and the roll shade or blind removed.

FIG. 8 is a side view of FIG. 1 with the left side end bracket assembly removed.

### DETAILED DESCRIPTION

The invention will now be described with reference to the drawing figures, in which like reference numerals refer to like parts throughout. An embodiment in accordance with the present invention provides a left and right bracket assembly for supporting a window covering. The left and right bracket assembly is concealed, at least in part, by a valance. The valance is configured to pivot to alternately expose and conceal the bracket assemblies and window covering.

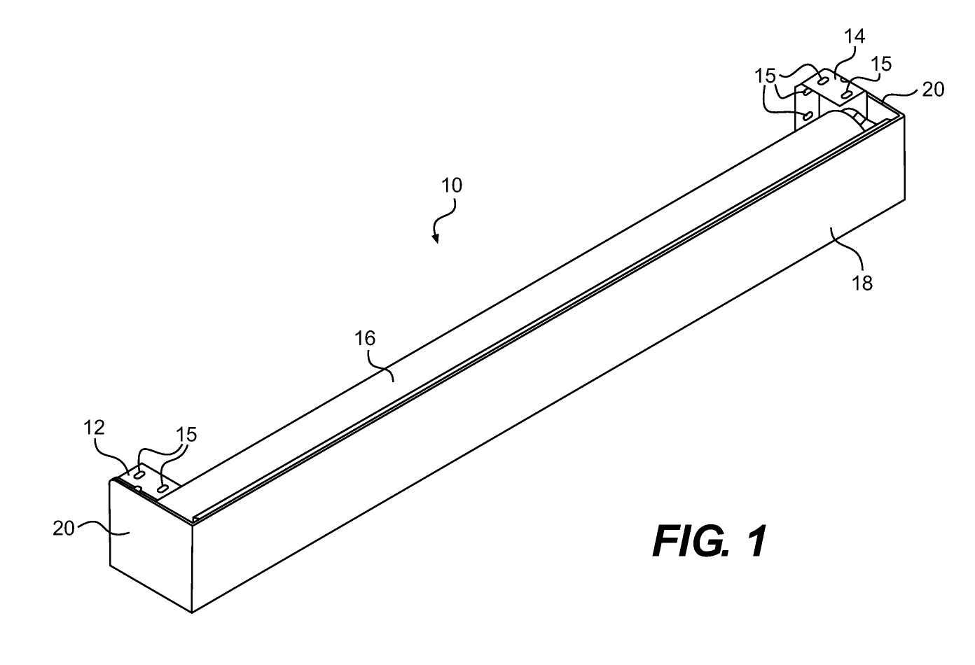

FIG. 1 shows the shade/blind assembly 10. The shade/blind assembly 10 includes a left bracket assembly 12 and a right bracket assembly 14. The left 12 and right 14 bracket assemblies support the window covering 16. As shown in FIG. 1, the window covering 16 is a roller shade 16. In other embodiments, the window covering 16 could be a blind or any other suitable window covering. The bracket assemblies 12 and 14 have mounting holes 15 to allow the bracket assemblies 12 and 14 to be mounted to a wall or window sill with fasteners as is well known.

The bracket assemblies 12 and 14 also support a valance 18 and end covers 20. The valance 18 and the end covers 20 hide the bracket assemblies 12 and 14 when the shade/blind assembly 10 is installed at a window.

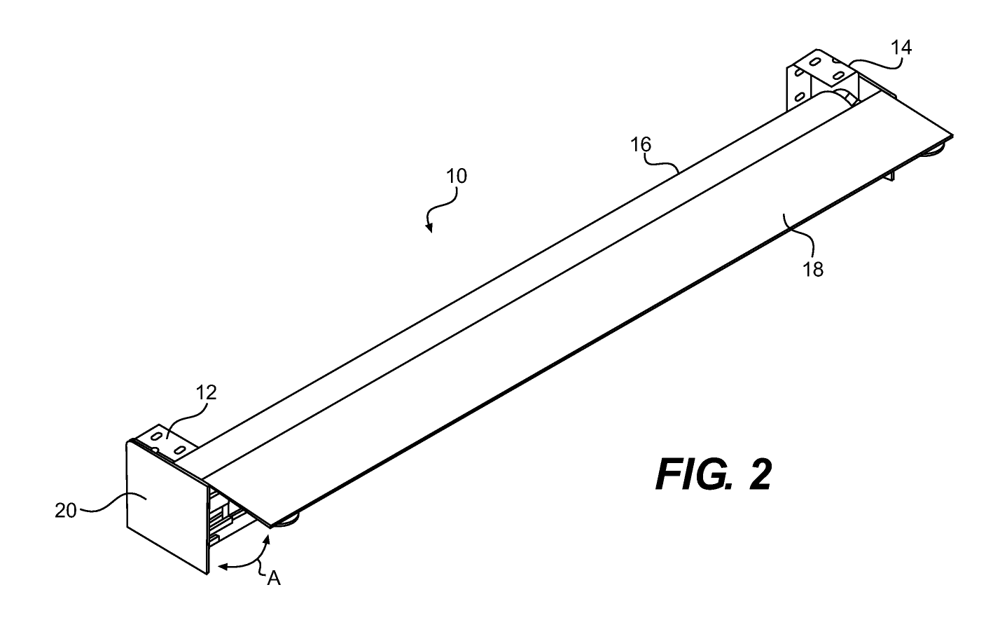

FIG. 2 shows the shade/blind assembly 10 with the valance 10 in a pivoted position. The valance 10 pivots in the direction as shown by arrow A in FIG. 2 to allow a user access to the window covering 16 and the bracket assemblies 12 and 14.

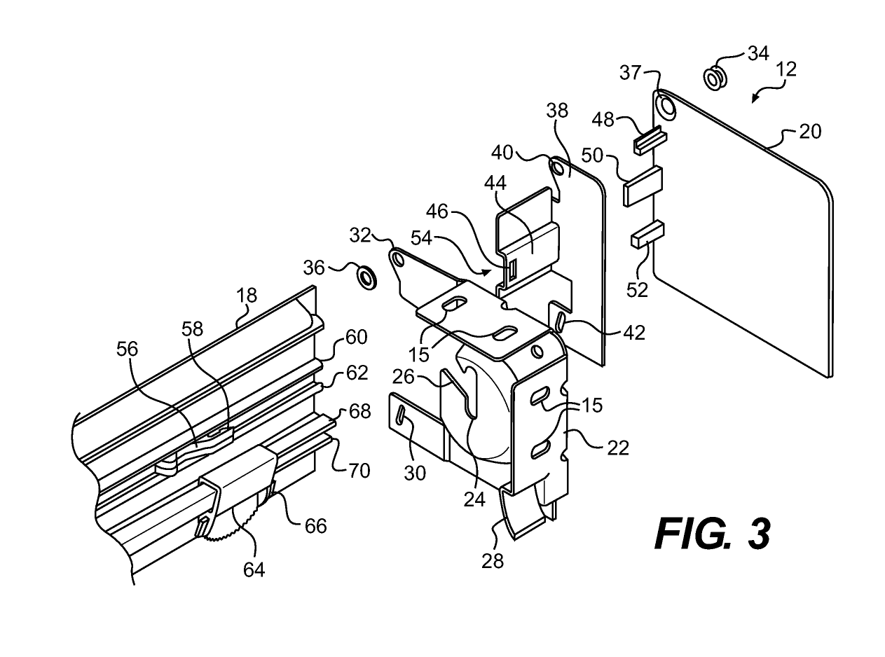

FIG. 3 is an exploded reverse view of the left bracket assembly 12 and part of the valance 18. While only the left bracket assembly 12 is shown and described in detail, it is understood that the right bracket assembly is very similar and need not be shown and described in detail. In some embodiments, the left and right bracket assemblies 12 and 14 are mirror images of each other.

FIG. 3 shows the bracket 22. The bracket 22 attaches to a wall or window via fasteners (not shown) mounted in the mounting holes 15. The bracket 22 has a slit 24 for mounting the axle of a roller shade 16 (see FIG. 1) and a ramped surface 26 to guide the axle into the slit 24 as is well known. It will be understood that features of the bracket 22 or the bracket assemblies 12 and 14 may be modified in accordance with the invention in order to provide suitable mounting features for the window covering 16 being used. While the FIGS. illustrate a roller shade, other types of window coverings 16 may also be used.

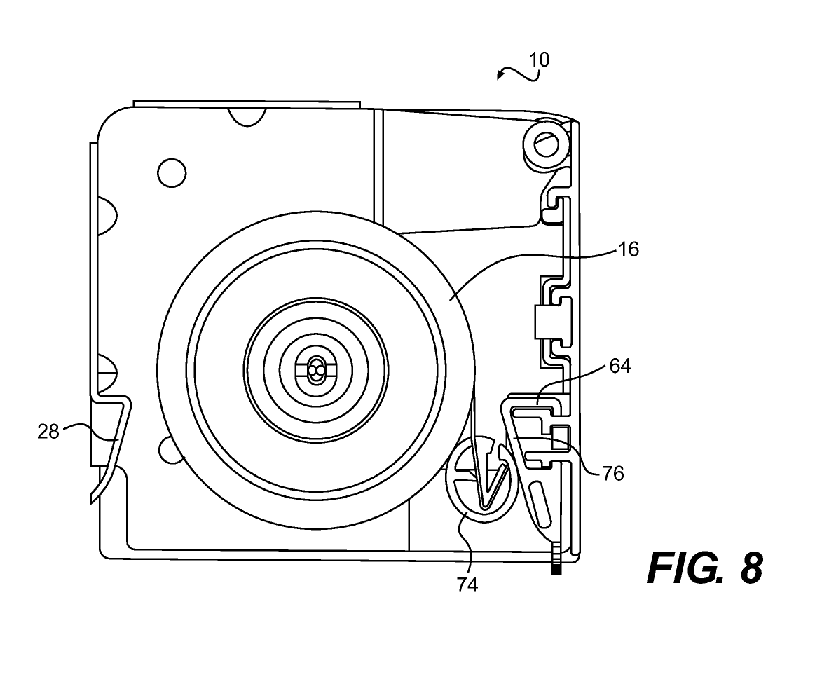

The bracket 22 as has a hard stop 28 and a slot 30. The hard stop 28 is configured to contact a thicker portion or bar 74 (see FIG. 8) of a roller shade 16 to prevent the roller shade from over rotating and spinning in a fully retracted position. The bracket 22 has a hole 32 configured to accept the rivet 34 and spring washer 36. The rivet 34 connects the end plate 20 and the pivot arm 38 by extending through holes 37, 40 and 32. The spring washer 36 generates friction with the rivet 34, thereby resulting in the pivot arm 38 staying in what ever position with respect the end plate 20 and bracket 22 the pivot 38 arm is placed.

The pivot arm 38 has a projection 44 and a slot 46 in the projection. The pivot arm 38 also has a slot 42. When the pivot arm 38 is rotated to a down position, the slot 42 on the pivot arm 38 will align with the slot 30 on the bracket 22.

The end plate 20 has alignment projections 48, 50, and 52. The alignment projections 48, 50, and 52 assist in aligning the end plate 20, the pivot arm 30, the bracket 22, and the valance 18. In some embodiments, the alignment projections 48, 50, and 52 may also provide support for one or more of these features. In some embodiments, the alignment projections 48, 50, and 52 may provide a stop to halt the rotation of the valance 18 in toward the window covering 16. In some embodiments, the alignment projection 50 fits into trench 54 on the back of the projection 44.

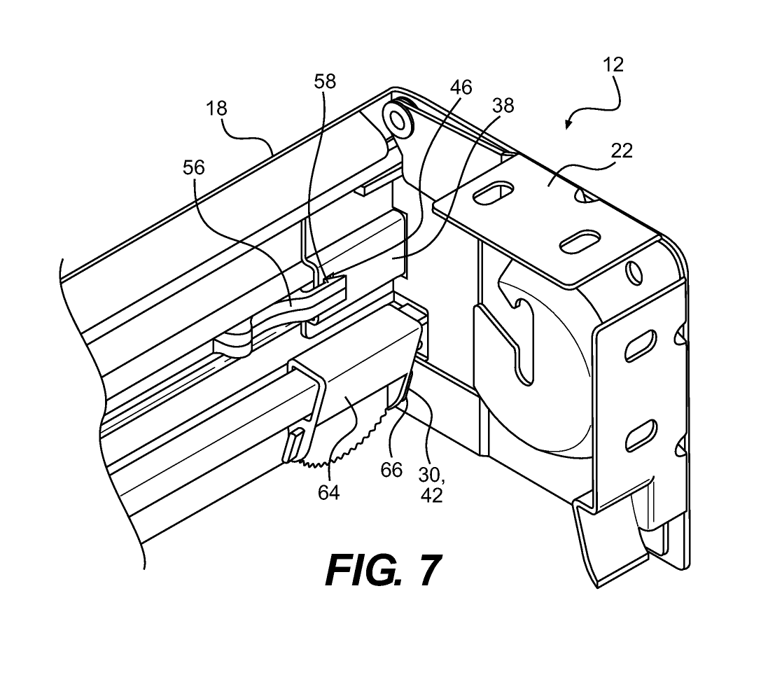

The valance 18 includes a first slide lock 56 having a locking protrusion 58. The first slide lock 56 slides between rails 60 and 62. The valance 18 also has a second slide lock 64. The second slide lock 64 is C-shaped and has a projection 66. The projection 66 fits into slots 30 and 42 to lock the valance 18 and pivot arm 38 to the bracket 22 as shown in FIG. 7. Returning to FIG. 3, the second slide lock 64 slides between rails 68 and 70 that are attached to the valance 18.

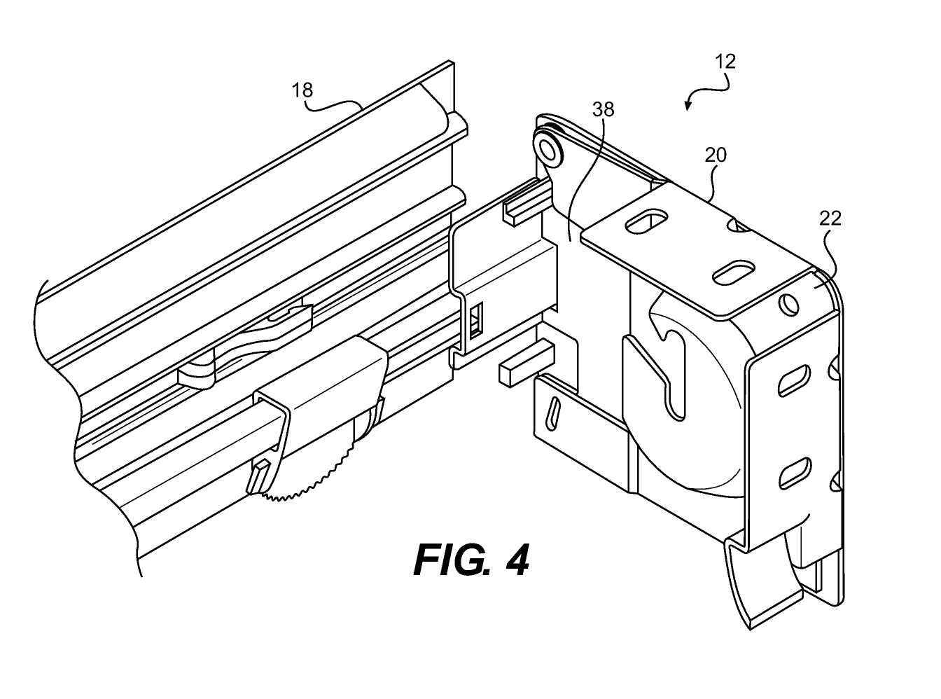

FIG. 4 shows the bracket 22, pivot arm 38 and end plate assembled to a bracket assembly 12. The bracket assembly 12 is not yet in contact with the valance 18.

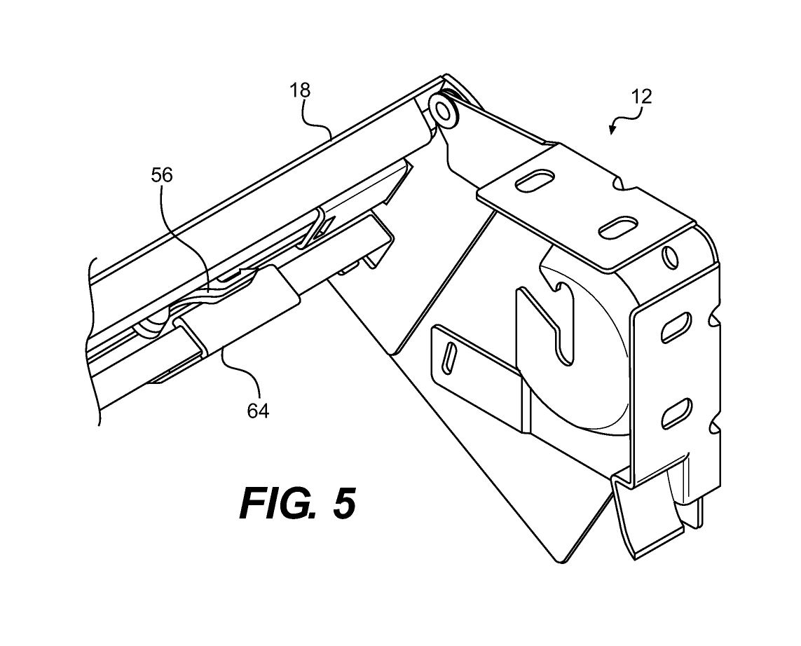

FIG. 5 shows the bracket assembly 12 attached to the valance 18. The valance 18 is pivoted with respect to the bracket assembly 12. The first and second locks 56 and 64 are shown in disengaged positions.

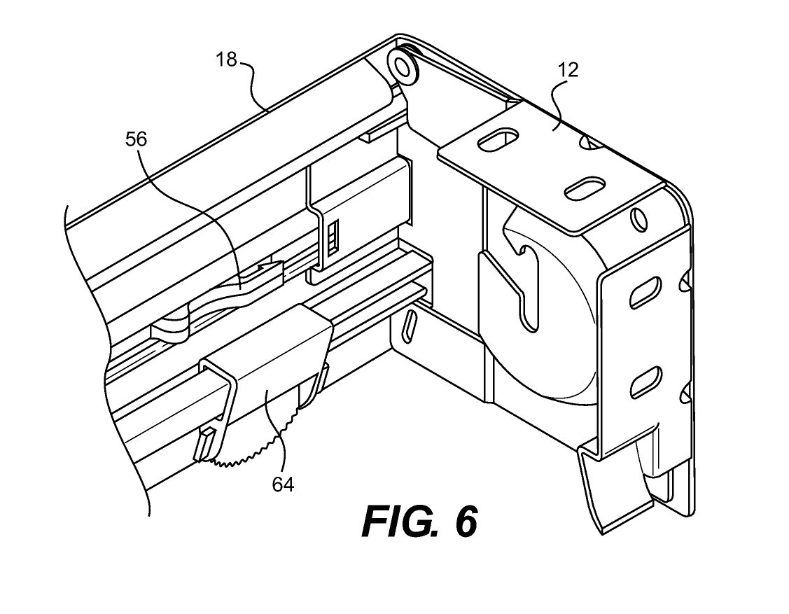

FIG. 6 shows the bracket assembly 12 attached to the valance 18. The valance 18 is in a position where the valance 18 is not pivoted away from the bracket assembly 12. The first and second locks 56 and 64 are shown in disengaged positions.

FIG. 7 shows the bracket assembly 12 attached to the valance 18. The valance 18 is in a position where the valance 18 is not pivoted away from the bracket assembly 12. The first and second locks 56 and 64 are shown in locked positions. The projection 58 on the first slide lock 56 has “snapped” into the slot 46 on the pivot arm 38. If only the first lock 56 was locked, the valance 18 would be attached to the bracket assembly 12 and the valance 18 could still pivot along with the pivot arm 38 away from the bracket 22. Locking the second slide lock 64 as shown causes the projection 66 to fit into aligned slots 30 and 42 (best shown in FIG. 3) which prevent the valance 18 from pivoting away from the bracket 22. Thus, as shown in FIG. 7, locking the first slide lock 56 locks the valance 18 to the bracket assembly 12 and locking the second lock 64 locks the valance 18 in place.

In some embodiments, both locks 56 and 64 are normally engaged, and the valance 18 is normally in a down position covering the roller shade or blinds 16. When a user desires to pivot the valance 18, the second lock 64 is slid to an unlocked position. A second lock 64 is associated with both the right and left side, thus, both second locks 64 are unlocked. The valance 18 then free to pivot. The valance 18 may be returned to the down position and the second locks 64 may be engaged to lock the valance 18 in place.

If it is desired to remove the valance, both locks 56 and 64 on each the right and left sides will be disengaged. Likewise to reinstall the valance 18, both locks 56 and 64 on each side will be engaged.

FIG. 8 shows a side view of the shade/bind assembly 10 shown in the other FIGS. Several of the features shown in the other FIGS. are shown in FIG. 8, and the descriptions of these features, except for what follows, will not be repeated there. The left bracket end assembly 12 is removed to better show the features of the shade/blind assembly 10. The roller shade 16 is shown in a retracted position. The roller shade 16 has thicker portion or bar 74 at the end of the shade 16 that may be used as a handle. The thicker portion or bar 74 may extend the width of the shade 16 or some other length. The side of the second lock 64 serves as a stop 76 by trapping the thicker portion or bar 74 to prevent the roller shade 16 from over rotating.

As shown in FIG. 8 the roller shade 16 may be pulled down from the right of the shade 16. In other embodiments, the roller shade 16 may be reversed, in which case the wide portion or bar 74 would be located to the left of the roller shade 16. In such embodiments the stop 28 may be used to trap the thicker portion or bar 74 and prevent the roller shade 16 from over rotating.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for supporting a window covering comprising:
a bracket assembly having a stationary portion and a pivoting portion;
a valance pivotally connected to the bracket assembly;
a first lock configured to lock the valance to the pivoting portion of the bracket assembly; and
a second lock that, when engaged, locks the valance to the stationary portion of the bracket assembly.

2. The system of claim 1, further comprising a retractable window covering concealed, at least in part, by the valance.

3. The system of claim 2, wherein the retractable window covering is one of a roller shade and a blind.

4. The system of claim 1, wherein the valance is configured to pivot between two positions, a first position where the valance conceals, at least in part, a retractable window covering and a second position where the valance exposes the retractable window covering to provide access to at least one of the retractable window covering and the bracket assembly.

5. The system of claim 1, further comprising a friction device connected to the valance and the bracket assembly to retain the valance in a given position with respect to the stationary portion of the bracket.

6. The system of claim 5, wherein the friction device is a spring washer.

7. The system of claim 1, further including a hard stop of the second lock, the hard stop configured to hinder a handle on the window covering from rotating around the window covering.

8. The system of claim 1, wherein when the first and second locks are unlocked, the valance is removable from the bracket assembly.

9. The system of claim 1, further comprising a hard stop mounted on the bracket assembly, the hard stop configured to hinder a handle on the window covering from rotation around the window covering.

10. The system of claim 1, further comprising a channel formed by ridges on the valance and at least one of the first and second locks are slidably mounted in the channel.

11. The system of claim 1, further comprising an alignment protrusion located on the bracket assembly configured to align the valance with the bracket assembly and support the valance on the bracket assembly.

12. The system of claim 11, further comprising end plates as part of the bracket assembly and the alignment protrusion is located on the end plate.

13. The system of claim 1, wherein the first lock includes a snap member that snaps into a slot in the pivoting portion of the bracket assembly.

14. The system of claim 1, wherein the second lock includes a protrusion that fits into an slot in a protrusion in the stationary portion of the bracket assembly.

15. A method of concealing a window covering comprising:
providing a bracket assembly configured to support the window covering;
providing a valance attached to the bracket assembly;
pivoting the valance on the bracket assembly to selectively expose and conceal the window covering;
locking the valance to a pivoting portion of the bracket assembly; and
locking the valance to a stationary portion of the bracket assembly.

16. The method of claim 15, wherein the locking steps are accomplished by sliding locks mounted to the valance.

17. The method of claim 15, further comprising aligning the valance with a side plate by aligning protrusions on the side plate with features on the valance.

18. The method of claim 15, further comprising maintaining the valance in a pivoted position by generating friction between the valance and the bracket assembly with a spring washer.

19. The method of claim 15, further comprising stopping the window covering from rotating by blocking a handle on the window covering with a stop on one of any of the locks and the bracket assembly.

20. A system for supporting a window covering comprising:
a means for supporting the window covering having a stationary portion and a pivoting portion;
a concealing means pivotally connected to the means for supporting the window covering;
a first means for locking configured to lock the concealing means to the pivoting portion of the means for supporting the window covering; and
a second locking means that, when engaged, locks the concealing means to the stationary portion of the means for supporting the window covering.
